(19) United States
(12) Patent Application Publication
(10) Pub. No.: US 2020/0108355 A1
(43) Pub. Date: Apr. 9, 2020

(54) POLYMER MEMBRANE WITH ARABIC GUM FOR WATER TREATMENT

(71) Applicant: Qatar Foundation for Eduction, Science and Community Development, Doha (QA)

(72) Inventors: Muataz Hussien, Doha (QA); Souhir Sabri, Doha (QA); Viktor Kochkodan, Doha (QA); Yehia Manawi, Doha (QA); Huda Alsuliti, Doha (QA)

(21) Appl. No.: 16/591,251

(22) Filed: Oct. 2, 2019

Related U.S. Application Data
(60) Provisional application No. 62/740,522, filed on Oct. 3, 2018.

(51) Int. Cl. B01D 71/12; B01D 71/68; B01D 65/08; C02F 1/44

(52) U.S. Cl. CPC B01D 71/12; B01D 71/68; C02F 2103/08; C02F 1/44; B01D 65/08

(57) ABSTRACT

The present disclosure provides for a water treatment system including a water tank and a polymer membrane. The water tank includes an inlet in fluid communication with an outlet. The polymer membrane is contained within the water tank and includes Arabic gum so as to minimize biofouling. The polymer membrane may include 0.1% to 7% by weight of Arabic gum. The water tank is configured such that an untreated water stream entering at the inlet is treated by passing the untreated water stream through the polymer membrane before exiting at the outlet.

### PRIORITY CLAIM

The present application claims priority to and the benefit of U.S. Provisional Application 62/740,522 filed on Oct. 3, 2018, the entirety of which is incorporated herein by reference.

### BACKGROUND

Biofouling is a critical issue in membrane water and wastewater treatment as it greatly compromises the efficiency of the treatment processes. It is difficult to control, and significant economic resources have been dedicated to the development of effective biofouling monitoring and control strategies. Thermoplastic materials are conventionally used for preparation of polymer membranes. Two of the most widely used polymers in casting of polymer membranes are polysulfone (PSF) and polyethersulfone (PES), which are frequently employed because of their high mechanical strength and chemical stability. Despite high structural and chemical stability, the membranes made from thermoplastic polymers possess low porosity and high hydrophobicity that often results in severe membrane biofouling. Therefore, an increase in flux and hydrophilicity of polymeric membranes is highly desirable to minimize biofouling and increase their productivity and efficiency when used for long periods of time in water treatment systems.

In some instances, an additive may be used when casting the thermoplastic membranes in order to increase the porosity and flux of the membranes and provide antifouling properties for the membranes. Some conventionally used additives include polyvinyl pyrrolidone (PVP) in a system of PSF/N-methyl-2-pyrrolidone, PSF/dimethyl acetamide (DMAc), polyethylene glycol in a polyvinylidene difluoride/dimethyl formamide (DMF), maleic acid in a system of cellulose acetate/dioxane, and glycerol in a system of PSF/DMAc.

Some of these additives help in producing membranes with more macro-voids, whereas others surpass the formation of macro-voids. Surpassing the formation of macro-voids results in the enhancement of the interconnectivity of pores and the formation of higher membrane porosities. PVP is commonly used due to its high solubility in water and good miscibility with PSF. However, it is known that PVP additive has opposite effects when used in casting solutions of PSF, as compared to PES, at least in terms of the formation of macro-pores or macro-voids.

### SUMMARY

The present disclosure generally relates to systems and methods of water treatment that minimize biofouling of a polymer membrane. More specifically, the present disclosure relates to systems and methods of water treatment that utilize a polymer membrane including Arabic gum.

In one aspect of the present disclosure, which may be combined with any other aspect, a water treatment system is provided comprising a water tank and a polymer membrane. The water tank includes an inlet in fluid communication with an outlet. The polymer membrane is contained within the water tank and includes Arabic gum so as to minimize biofouling. The water tank is configured such that an untreated water stream entering at the inlet is treated by passing the untreated water stream through the polymer membrane before the treated water stream exits at the outlet.

In another aspect of the present disclosure, which may be combined with any other aspect, the polymer membrane includes polysulfone.

In another aspect of the present disclosure, which may be combined with any other aspect, the polymer membrane includes between 0.1% to 7% by weight of Arabic gum.

In another aspect of the present disclosure, which may be combined with any other aspect, the polymer membrane minimizes biofouling against at least one bacteria selected from the group consisting of a Gram-positive bacteria and a Gram-negative bacteria.

In another aspect of the present disclosure, which may be combined with any other aspect, the polymer membrane minimizes biofouling against at least one bacteria selected from the group consisting of Escherichia coli, Pseudomonas aeruginosa, Klebsiella pneumonia, isolate of Salmonella, and Staphylococcus aureus.

In another aspect of the present disclosure, which may be combined with any other aspect, the untreated water stream is at least one selected from the group consisting of sewage, seawater, and ground water.

In another aspect of the present disclosure, which may be combined with any other aspect, the polymer membrane removes from the untreated water stream at least one of the group consisting of a fungus, a virus, and a protozoa.

In another aspect of the present disclosure, which may be combined with any other aspect, a method is provided comprising providing a polymer membrane including Arabic gum, providing an untreated water stream, and treating the untreated water stream by directing it through the polymer membrane. The polymer membrane minimizes biofouling.

Additional features and advantages are described herein, and will be apparent from the following Detailed Description and the figures.

### BRIEF DESCRIPTION OF THE DRAWINGS

Features and advantages of the water treatment systems and methods described herein may be better understood by reference to the accompanying drawings in which:

FIG. 1 illustrates an example water treatment system, according to an aspect of the present disclosure.

FIG. 2 is a flow chart of an example water treatment method, according to an aspect of the present disclosure.

FIGS. 3a to 3a illustrate scanning electron microscope images of PSF membrane surfaces with 7 wt % Arabic gum (left) compared to PSF membrane surfaces without Arabic gum (right) after incubation with five strains of bacteria.

The reader will appreciate the foregoing details, as well as others, upon considering the following detailed description of certain non-limiting embodiments of the systems and methods according to the present disclosure. The reader may also comprehend certain of such additional details upon using the systems and methods described herein.

### DETAILED DESCRIPTION

The present disclosure generally relates to systems and methods of water treatment that minimize biofouling of a polymer membrane. More specifically, the present disclosure is directed to water treatment systems and methods utilizing a polymer membrane including Arabic gum in order to minimize biofouling and provide antimicrobial features.

Membrane fouling is a major problem encountered in membrane filtration processes, and it is a major factor in determining their practical application in water and wastewater treatment and desalination in terms of technology and economics. Membrane fouling includes inorganic fouling/scaling, organic fouling, particulate/colloidal fouling and biofouling (or microbial/biological fouling). Fouling due to organic and inorganic components and microorganisms can occur simultaneously, and these components may interact in terms of mechanism. Biofouling represents a limiting factor of the membrane process because microorganisms can multiply over time. For instance, even if 99.9% of them are removed, there are still enough cells remaining that can continue to grow at the expense of biodegradable substances in the feed water.

Biofouling can have several adverse effects on membrane water treatment systems. For instance, membrane flux may decline due to the formation of a low permeability biofilm on the membrane surface. An increased differential pressure and feed pressure may be needed to maintain the same production rate due to biofilm resistance. Membrane biodegradation may be caused by acidic by-products that are concentrated at the membrane surface. For example, cellulose acetate membrane has been found to be more susceptible to being biodegraded. Biofouling may also cause an increased salt passage through the membrane and a reduced quality of the product water due to the accumulation of dissolved ions in the biofilm at the membrane surface thus increasing the degree of concentration polarization. It may further cause increased energy consumption due to higher pressure being required to overcome the biofilm resistance and the flux decline.

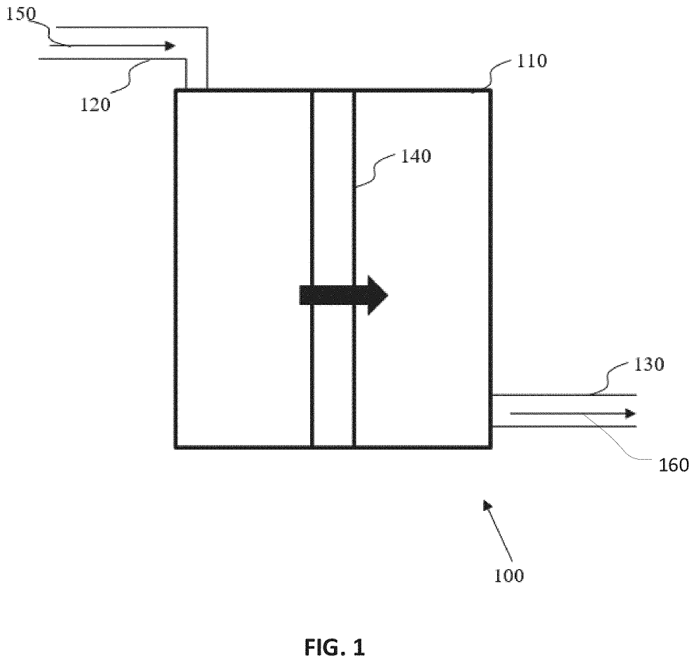

Accordingly, the present disclosure provides for water treatment systems and methods that include a polymer membrane for minimizing biofouling more effectively than conventional polymer membranes, in order to increase the efficiency and effectiveness of the water treatment systems and methods. FIG. 1 illustrates a cross-section of an example water treatment system 100, according to one aspect of the present disclosure. The example system 100 includes a water tank 110 that includes an inlet 120 and an outlet 130. The inlet 120 and the outlet 130 are in fluid communication with one another such that a fluid may flow into the water tank 110 at the inlet 120 and out of the water tank 110 at the outlet 130. The water tank 110 may be any suitable housing for directing a water stream 150 from the inlet 120 to the outlet 130. The inlet 120 and the outlet 130 may have any suitable design for directing water or other fluid into and out of the water tank 110, respectively, and may be connected to piping, hosing, or other means for transporting water or other fluid. For example, the inlet 120 and outlet 130 may extend from the water tank 110 as illustrated in FIG. 1, or in other examples, may be openings on the ends of the water tank 110 that do not extend outward. In such other examples, the water tank 110, rather than the inlet 120 and outlet 130, may be connected to piping, hosing, or other means for transporting water or other fluid.

The example system 100 also includes a polymer membrane 140 contained within the water tank 110. The polymer membrane 140 is additionally in fluid communication with the inlet 120 and the outlet 130. In various examples, the polymer membrane 140 extends to the outer perimeter of the water tank 110 interior such that untreated water entering at the inlet 120 must pass through the polymer membrane 140 prior to exiting at the outlet 130. Accordingly, the water stream 150 may enter the water tank 110 at the inlet 120 in the direction of the illustrated arrow as untreated water, pass through the polymer membrane 140 in the direction of the illustrated arrow to be treated, and the treated water stream 160 may exit the water tank 110 at the outlet 130 in the direction of the illustrated arrow. The water stream 150, in various examples, may be sewage, seawater, ground water, or other suitable water for treatment. Treating the water, in some instances, may include removing a fungus, a virus, a protozoa, or other contaminants from the water.

The polymer membrane 140 includes Arabic gum and at least one polymer. Arabic gum, also known as gum Arabic or acacia gum among other names, is a natural, complex polysaccharide consisting of the hardened sap of various species of the acacia tree, and has been found, based on this disclosure, to provide antimicrobial properties suitable for water treatment. In some aspects of the present disclosure, the membrane 140 may include PSF mixed or blended with Arabic gum. In other aspects of the present disclosure, the membrane 140 may include Arabic gum mixed or blended with other polymers, such as cellulose acetate, polyamide, polyvinylidene fluoride, PES, polyvinyl chloride, polyimide, polyacrylonitrile, polyvinyl alcohol, poly(methacrylic acid), poly(arylene ether ketone), poly(ether imide), and polyaniline.

In various aspects, the polymer membrane includes between 0.1% to 7% by weight of Arabic gum. For example, the polymer membrane may include 0.1, 0.5, 1.0, 1.5, 2.0, 3.0 or 7 wt % Arabic gum. In other examples, the polymer membrane may include more or less Arabic gum. The addition of Arabic gum to the polymer membrane 140 helps limit biofouling of the polymer membrane 140. In some instances, the polymer membrane 140 may advantageously reduce biofouling against bacteria including Escherichia coli, Pseudomonas aeruginosa, Klebsiella pneumonia, isolate of Salmonella, and Staphylococcus aureus, along with other bacteria that cause biofouling. Accordingly, the example water system 100 may have increased efficiency due to the reduction of biofouling of the polymer membrane 140 because of the inclusion of Arabic gum in the polymer membrane 140.

Escherichia coli is a member of a group of organisms known as coliforms: common bacteria found in the digestive system of humans and animals. One strain of E. coli is responsible for causing Traveler's diarrhea, and another strain, E. coli O157:H7, contaminates meat and leafy vegetables. Staphylococcus aureus is a Gram-positive bacteria that causes a wide variety of clinical manifestations. This bacteria is considered to be a major pathogen that colonizes and infects both hospitalized patients with decreased immunity, and healthy immuno-competent people. Staphylococcus. aureus is found in the environment and is also found in normal human flora, located on the skin and mucous membranes.

Klebsiella pneumonia is a Gram-negative bacterium that causes nosocomial, urinary tract, and wound infections. It can be found in the normal flora of the mouth, skin, and intestines. Salmonella is a Gram-negative, rod-shaped bacteria belonging to the Enterobacteriaceae family. Salmonella constitutes a genus of zoonotic bacteria of worldwide economic and health importance. The majority of human infection of Salmonella is related to the ingestion of contaminated foods such as poultry, beef, pork, egg etc. Salmonella is frequently detected in surface waters including recreational waters and waters used for irrigation or as a drinking water source. The Gram-negative bacteria Pseudomonas aeruginosa has become an important cause of infection such as pneumonia, urinary tract infections, especially in patients with compromised host defense mechanisms. It is the most common pathogen isolated from patients who have been hospitalized longer than 1 week.

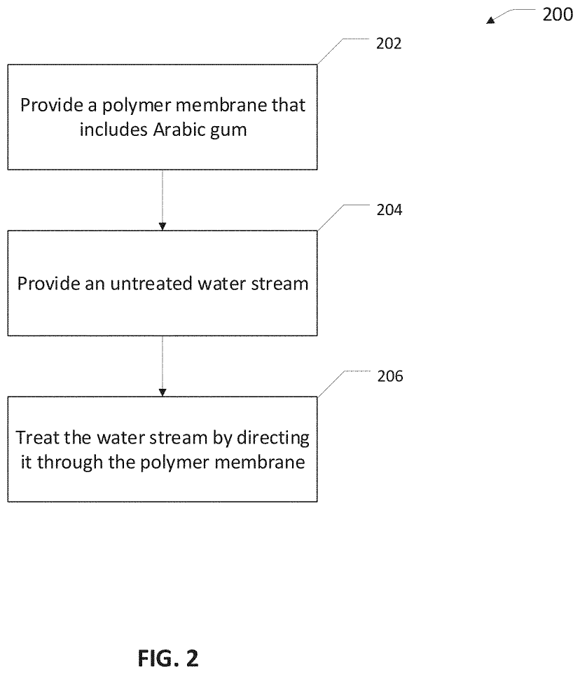

FIG. 2 illustrates an example method 200 for treating water, according to an aspect of the present disclosure. Although the examples below are described with reference to the flowchart illustrated in FIG. 2, many other methods of performing the acts associated with FIG. 2 may be used. For example, the order of some of the blocks may be changed, certain blocks may be combined with other blocks, one or more of the blocks may be repeated, and some of the blocks described may be optional. At step 202, the method 200 includes providing a polymer membrane that includes Arabic gum (e.g., the polymer membrane 140). At step 204, an untreated water stream is provided. The untreated water stream may be, for example, sewage, seawater, ground water, or other suitable water for treatment. At step 206, the water stream is treated by being directed though the polymer membrane that includes Arabic gum (e.g., the polymer membrane 140). Treating the water, in some instances, may include removing a fungus, a virus, a protozoa, or other contaminants from the water. Accordingly, the example water treatment method 200 may have increased efficiency due to the reduction of biofouling of the polymer membrane that includes Arabic gum because of the inclusion of Arabic gum in the polymer membrane.

To demonstrate the effectiveness of PSF membranes incorporated with Arabic gum at reducing biofouling, various experiments were performed. PSF membranes incorporated with Arabic gum were cast via a phase inversion method using a flat sheet membrane casting system, such as the one manufactured by Philos Co., Ltd of South Korea. The membrane samples were prepared with different concentrations of Arabic gum, specifically: 0.1, 0.5, 1.0, 1.5, 2.0, 3.0 and 7 wt % in a homogeneous (dope) 16 wt % PSF/DMAc solution. For the preparation of the casting solutions, DMAc, PSF and Arabic gum were sonicated using a probe ultra-sonicator, such as the one manufactured by Cole Parmer of USA, and mixed using an IKA Ultra Turrax T25 digital mechanical stirrer, such as the one manufactured by IKA of USA, for about two hours at a temperature of 60° C. to ensure that the PSF and the Arabic gum dissolved in the solvent. The resultant solution was then degassed for about six hours and cast onto a clean glass plate using a casting knife with a gap height of 200 μm at a casting speed of 2.5 m/min at room temperature. The glass plate with the cast membrane film was immersed in distilled water and kept until the membrane was detached from the glass plate. The membranes were then washed and kept in distilled water for 24 hours at room temperature to remove traces of the solvent. For comparison, membrane samples with PVP (5 wt % in the dope solution) were also cast under the same conditions.

The antimicrobial properties of the membranes were evaluated using Staphylococcus aureus as a model of Gram-positive bacteria and four strains of Gram-negative bacteria: Escherichia coli, Klebsiella pneumonia, Pseudomonas aeruginosa, and a Salmonella isolate. The bacterial suspensions were prepared from an 18-hours-old nutrient broth culture from the above-motioned bacteria. The bacterial cell density was measured at an optical density (OD) of 600 nm using a spectrophotometer. The membranes prepared in the laboratory as well as the commercial membranes were disinfected by 70% ethanol and then dipped in sterilized water, dried in a laminar flow hood, and immersed 10 min in the bacterial suspension adjusted at 2.4×10⁷ CFU/ml by dilution in a nutrient broth. Using sterile tweezers, the membranes were gently placed on nutrient agar plates and placed in an incubator at 37° C. for 24 hours. After incubation, the membranes were placed gently on new sterilized petri dishes and then fixed by 4% paraformaldehyde in a phosphate buffered saline buffer for 30 min at room temperature. After fixation, the cells were washed twice in the phosphate buffer solution and then dried in a laminar flow hood. All the samples were sputtered with gold before scanning electron microscope (SEM) measurement.

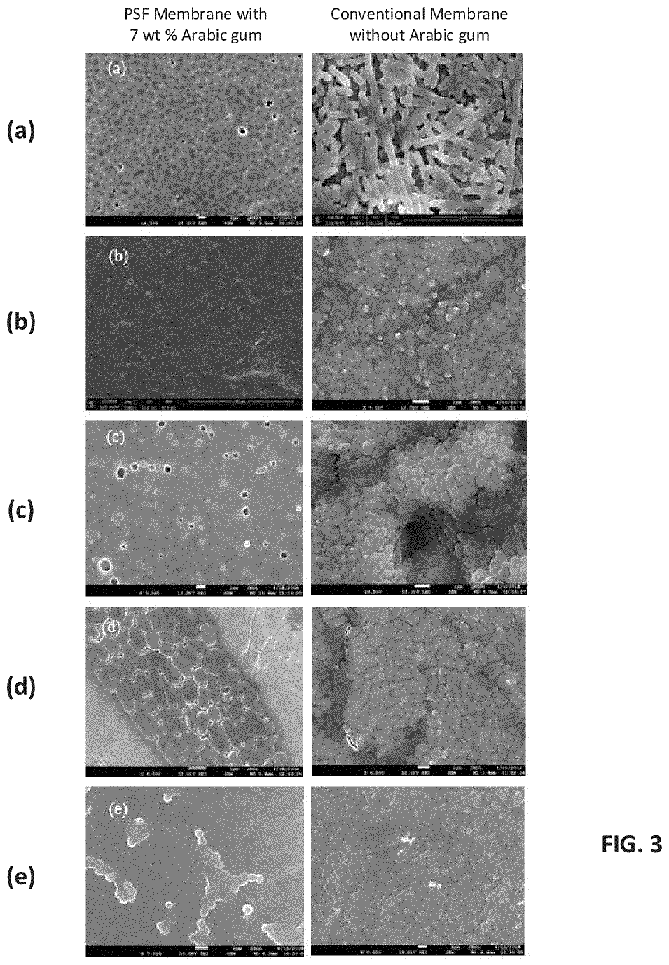

FIGS. 3a to 3e illustrate SEM images of the membrane surfaces after the incubation with the five different bacterial suspensions. The images in the left column illustrate a PSF membrane with 7 wt % Arabic gum, whereas the images in the right column illustrate conventional PSF membranes without Arabic gum. The images in FIG. 3a correspond to the membranes incubated with Escherichia coli. The images in FIG. 3b correspond to the membranes incubated with Klebsiella pneumonia. The images in FIG. 3c correspond to the membranes incubated with Pseudomonas aeruginosa. The images in FIG. 3d correspond to the membranes incubated with the Salmonella isolate. The images in FIG. 3e correspond to the membranes incubated with Staphylococcus aureus.

The addition of Arabic gum to the casting solutions enhanced the PSF membrane antimicrobial properties. For instance, each of the surface images in FIGS. 3a to 3e of the conventional PSF membranes without Arabic gum in the column on the right illustrate a greater amount of bacteria than the respective image of the PSF membrane with 7 wt % Arabic gum in the column on the left. Therefore, the addition of Arabic gum prevented bacteria from growing on the surface of a membrane to a greater degree than membranes without Arabic gum. Accordingly, PSF membranes with Arabic gum minimize biofouling of the membranes as compared to PSF membranes without Arabic gum.

Without further elaboration, it is believed that one skilled in the art can use the preceding description to utilize the claimed inventions to their fullest extent. The examples and embodiments disclosed herein are to be construed as merely illustrative and not a limitation of the scope of the present disclosure in any way. It will be apparent to those having skill in the art that changes may be made to the details of the above-described embodiments without departing from the underlying principles discussed. In other words, various modifications and improvements of the embodiments specifically disclosed in the description above are within the scope of the appended claims. For example, any suitable combination of features of the various embodiments described is contemplated.

The invention is claimed as follows:

1. A water treatment system comprising:
a water tank including an inlet in fluid communication with an outlet; and
a polymer membrane contained within the water tank, wherein the polymer membrane includes Arabic gum so as to minimize biofouling,
wherein the water tank is configured such that an untreated water stream entering at the inlet is treated by passing the untreated water stream through the polymer membrane before the treated water stream exits at the outlet.

2. The water treatment system of claim 1, wherein the polymer membrane includes polysulfone.

3. The water treatment system of claim 1, wherein the polymer membrane includes between 0.1% to 7% by weight of Arabic gum.

4. The water treatment system of claim 1, wherein the polymer membrane minimizes biofouling against at least one bacteria selected from the group consisting of a Gram-positive bacteria and a Gram-negative bacteria.

5. The water treatment system of claim 4, wherein the polymer membrane minimizes biofouling against at least one bacteria selected from the group consisting of Escherichia coli, Pseudomonas aeruginosa, Klebsiella pneumonia, isolate of Salmonella, and Staphylococcus aureus.

6. The water treatment system of claim 1, wherein the untreated water stream is at least one selected from the group consisting of sewage, seawater, and ground water.

7. The water treatment system of claim 1, wherein the polymer membrane removes from the untreated water stream at least one of the group consisting of a fungus, a virus, and a protozoa.

8. A water treatment method comprising:
providing a polymer membrane including Arabic gum, wherein the polymer membrane minimizes biofouling;
providing an untreated water stream; and
treating the untreated water stream by directing it through the polymer membrane.

9. The water treatment method of claim 8, wherein the polymer membrane includes polysulfone.

10. The water treatment method of claim 8, wherein the polymer membrane includes between 0.1% to 7% by weight of Arabic gum.

11. The water treatment method of claim 8, wherein the polymer membrane minimizes biofouling against at least one bacteria selected from the group consisting of a Gram-positive bacteria and a Gram-negative bacteria.

12. The water treatment method of claim 11, wherein the polymer membrane minimizes biofouling against at least one bacteria selected from the group consisting of Escherichia coli, Pseudomonas aeruginosa, Klebsiella pneumonia, isolate of Salmonella, and Staphylococcus aureus.

13. The water treatment method of claim 8, wherein the untreated water stream is at least one selected from the group consisting of sewage, seawater, and ground water.

14. The water treatment method of claim 8, wherein the polymer membrane removes from the untreated water stream at least one of the group consisting of a fungus, a virus, and a protozoa.
